(19) United States
(12) Patent Application Publication
(10) Pub. No.: US 2011/0189894 A1
(43) Pub. Date: Aug. 4, 2011

(54) COMPACT FLUORESCENT LIGHT FIXTURES AND RELATED LAMP CONVERSION KITS AND ADAPTERS

(76) Inventors: Donald G. Hirsh, Chapel Hill, NC (US); Matthew Sean Hilliard, Raleigh, NC (US)

(21) Appl. No.: 12/992,231

(22) PCT Filed: May 19, 2009
(86) PCT No.: PCT/US09/03091

§ 371 Date: Feb. 28, 2011

Related U.S. Application Data
(60) Provisional application No. 61/054,646, filed on May 20, 2008.

(51) Int. Cl. H01R 13/66; H01R 33/22

(52) U.S. Cl. 439/620.02; 439/664

(57) ABSTRACT

The disclosure describes devices that are used in conjunction with a pair of (single wattage) compact fluorescent lamps (CFL). In some embodiments, the devices can emulate the behavior of a 3-way incandescent bulb used in a standard 3-way lamp socket. Such can allows people to retain the benefits of their existing Edison-base (E26d) 3-way lamps with the improved energy efficiency and color temperature of modern CFL technology in a cost effective and flexible way. Light fixture conversion kits for allowing an incandescent lamp to accept CFL bulbs are also described.

### RELATED APPLICATION

This application claims the benefit of priority to U.S. Provisional Application Ser. No. 61/054,646, filed May 20, 2008, the contents of which are hereby incorporated by reference as if recited in full herein.

### FIELD OF THE INVENTION

The invention relates to lighting fixtures.

### BACKGROUND OF THE INVENTION

Three-way incandescent lamps became popular and inexpensive items because the incremental cost to manufacture them was slight, relative to the cost of manufacture of a conventional single-wattage incandescent lamp. The costs of adding a third conductor (the evolution from the E26 to the E26d sockets and base) and a second filament and support structure to an existing vacuum chamber were minor relative to the increased functionality of the bulbs. As a result, 3-way lamps (electrically, an E26d socket and 4-position switch) became popular with both consumers and manufacturers and bulbs were produced in a wide variety of wattages (100-200-300, 50-200-250, 50-100-150, 30-70-100) in many lighting applications.

Recently, compact fluorescent lamps (CFLs) have become popular and are replacing conventional incandescent bulbs (also known as Edison-type filament light bulbs) due to the “green” nature of their operation, e.g., lower energy requirements and longer operating life. Others have proposed bases which allow pin-based fluorescent lamps to be used in conjunction with a standard, Edison-base sockets or other similar Edison-like arrangements in a luminaire or lamp fixture. Examples of these devices are described in U.S. Pat. Nos. 6,190,191 and 5,864,461.

Despite the above, there remains a need for alternate lamp designs/fixtures, including those that can accommodate CFL bulbs.

### SUMMARY OF EMBODIMENTS OF THE INVENTION

Embodiments of the present invention provide devices that are used in conjunction with a pair of single wattage compact fluorescent lamps (CFL).

In some embodiments, the devices can emulate the behavior of a 3-way incandescent bulb used in a standard 3-way lamp socket. Such can allows people to retain the benefits of their existing Edison-base (E26d) 3-way lamps with the improved energy efficiency and color temperature of modern CFL technology in a cost effective and flexible way.

Some embodiments are directed to light fixture conversion kits for allowing an incandescent lamp to accept CFL bulbs. The kits can include: (a) an adapter comprising a base with two female sockets, each having a respective axis, the axes being offset from each other in a Z dimension, extending upwardly at an angle that is between about 30-45 degrees from an axial centerline of the base, each socket configured to accept one single wattage CFL bulb; and (b) first and second single wattage CFL bulbs.

The adapter may include a user-switch that is in communication with an electrical path that allows the adapter to define three different electrical paths for a three-way light output to allow each one or both of the bulbs to be on or off, or to act as a single electrical path for both bulbs to be on or off.

The adapter may be configured to convert a three-way incandescent light fixture of a single incandescent bulb to be able to accept two CFL bulbs. The adapter can include an electric circuit that extends from the first and second sockets to the base, and wherein the electric circuit has a first path that activates a first bulb to an on position, a second path that activates a second bulb to an on position and a third path that activates both the first and second bulbs to an on position to thereby provide three different illumination configurations.

The base can be configured to allow the first and second sockets to rotate to orient the first and second sockets in a desired position relative to a lamp harp while maintaining electrical contact with a lamp base.

The base can include a base cavity with a spring loaded plunger therein. The spring loaded plunger can be configured to allow the adapter to rotate in a lamp socket while maintaining electrical contact with the lamp socket.

Other embodiments are directed to light fixture adapters for allowing an incandescent lamp to accept CFL bulbs. The adapters have a body with a base with two female sockets. The sockets extend upwardly at an angle that is between about 30-45 degrees from an axial centerline of the base, each socket configured to accept one single wattage CFL bulb.

The adapter body can include an electrical circuit with a first socket inner and outer conductors and a second socket inner and outer conductors, the first and second socket outer conductors connecting to an outer conductor on the base, the inner conductor of the second socket connecting to a middle conductor in the base, and the inner conductor of the first socket connecting to a center conductor in the base, whereby the adapter provides three different electrical paths for activating either the first socket on, the second socket on or both the first and second sockets on for a three-way light illumination options.

The base can have a base cavity and a plunger that extends through a lower portion thereof, the plunger cooperating with the adapter body to allow the adapter body to rotate while the plunger remains in contact with a lamp socket. The plunger may be a spring loaded plunger.

Still other embodiments are directed to light fixtures. The light fixtures include: (a) an incandescent lamp fixture comprising a female light socket; and (b) an adapter comprising a base with a threaded base cap and with two upwardly extending female sockets, each socket holding a respective single wattage CFL bulb. The adapter defines electrical paths to activate bulbs in both of the two sockets.

The light fixture can be a three-way light fixture. The adapter can define three different electrical paths for three different illumination configurations, including a first bulb only on, a second bulb only on, and first and second bulbs on concurrently.

The adapter can include a user (accessible) switch that engages an internal electrical switch that allows the adapter to act as a three-way light adapter or as a static single or dual light output. The base can have a base cavity with a spring-loaded plunger having a conductor therein that communicates with at least one of the first and second female light sockets in the adapter and contacts the lamp fixture socket. The plunger can be configured to allow the adapter to rotate with respect to the lamp fixture while the plunger is in electrical contact with the lamp fixture light socket.

Yet other embodiments are directed to light fixture adapters having a male base with a metal cap with external threads that mates to a light fixture socket. The base has a cavity with a plunger that extends therethrough. The plunger has a lowermost end portion and conductor that contacts a light fixture socket. The base cavity has a lower radially extending internal lip and an upper shelf, with a spring residing around the plunger trapped between the shelf and lip. The adapters are configured to rotate while the plunger remains extended to orient the sockets in a desired position.

Further features, advantages and details of the present invention will be appreciated by those of ordinary skill in the art from a reading of the figures and the detailed description of the preferred embodiments that follow, such description being merely illustrative of the present invention.

### BRIEF DESCRIPTION OF THE DRAWINGS

FIG. 1 is an enlarged perspective view of a lamp adapter according to embodiments of the present invention.

FIG. 2 is a front view of the adapter shown in FIG. 1 with two single wattage CFLs according to embodiments of the present invention as well as a prior art 3-way incandescent bulb, a prior art 3-way CFL, and a conventional 2-way lamp adapter with 2 CFLs.

FIG. 3A-3D are front views of different 3-way lamp switch positions. FIG. 3A illustrates the 3-way switch “off”, FIG. 3B illustrates position 1 with one CFL on. FIG. 3C illustrates position 2 with the second CFL “on” and FIG. 3D illustrates position 3 with both bulbs on.

FIG. 4 is a front perspective view of the adapter shown in FIG. 1, illustrating two different wattage CFL bulbs in the adapter according to embodiments of the present invention.

FIG. 5 is a partial cutaway view of an adapter with circuit connections for two sockets and a three-way switch according to embodiments of the present invention.

FIG. 6 is a partial cutaway view of an adapter with a rotational adjustment configuration for allowing electrical connection and Z-axis adjustability according to embodiments of the present invention.

FIGS. 7A and 7B illustrate a conventional lamp fixture with a harp and an adapter that can be adjusted relative to the harp for placement of the sockets and bulbs in the lamp harp according to embodiments of the present invention.

FIG. 8 is a greatly enlarged top view of the adapter shown in FIG. 1 illustrating the orientation of the two sockets according to embodiments of the present invention.

FIG. 9 is a partial cutaway view of an adapter with a circuit configuration for a one-way Edison lamp socket while allowing for two CFL bulbs according to embodiments of the present invention.

FIG. 10 is a partial cutaway view of an adapter with a circuit configuration with a switch to connect the different bulbs to the electrical source according to yet other embodiments of the present invention.

FIG. 11 is a front view of components of an exemplary lamp conversion kit according to embodiments of the present invention.

### DETAILED DESCRIPTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity. In the figures, broken lines illustrate optional features or operations unless specified otherwise. Features discussed with respect to one embodiment can be used with other embodiments.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention. The sequence of operations (or steps) is not limited to the order presented in the claims or figures unless specifically indicated otherwise.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

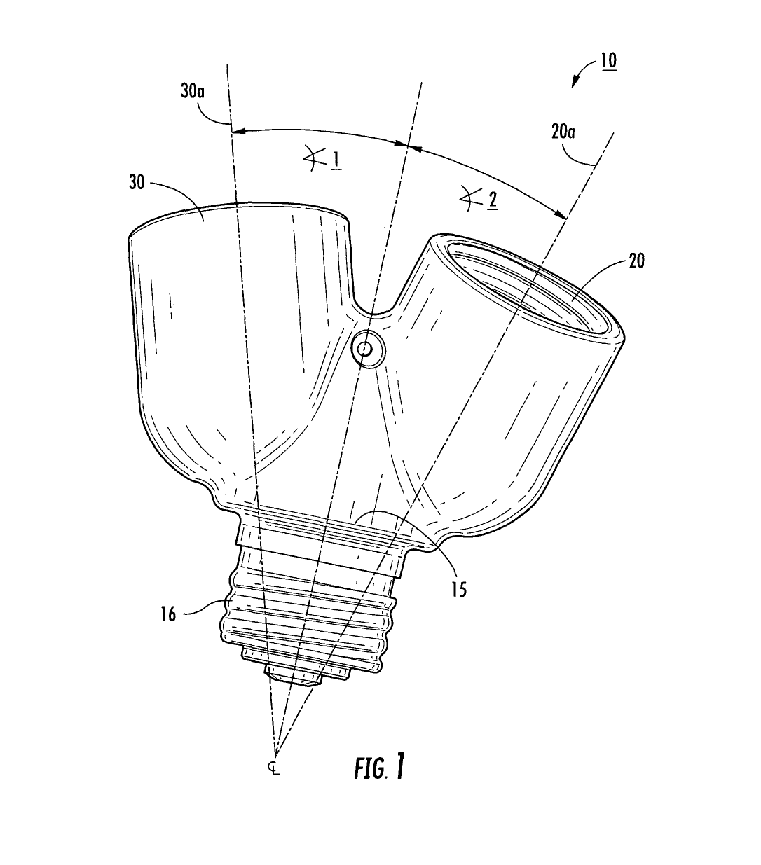

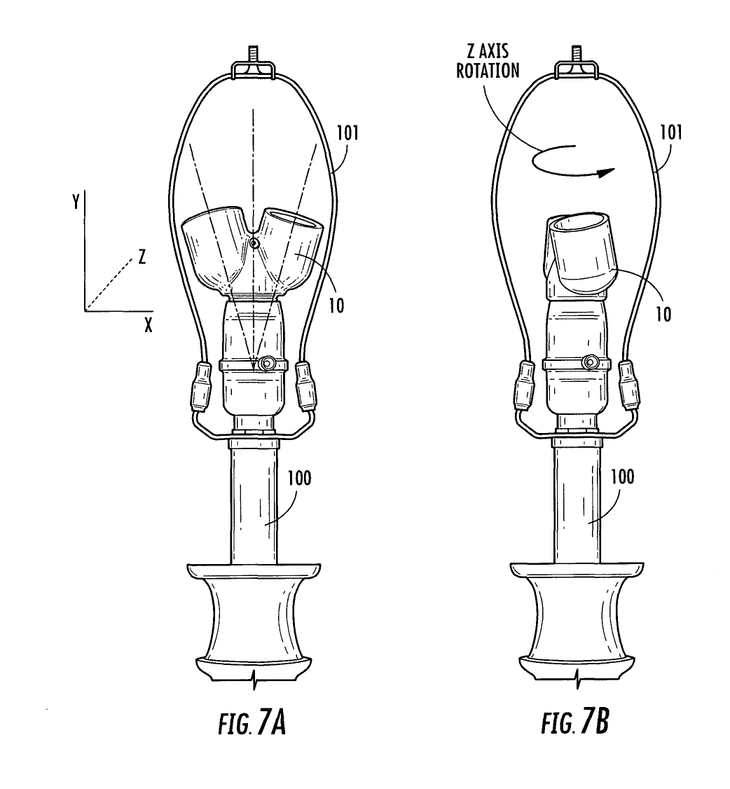

Turning now to the figures, FIG. 1 illustrates a lamp adapter 10. The lamp adapter 10 has a base 15 that attaches to a lamp fixture (100, FIGS. 7A, 7B). The base 15 can be constructed with a male lamp cap 16, such as an E26d lamp-cap (male). The base 15 holds two upwardly extending sockets 20, 30. The adapter 10 can have a substantially “Y” shaped housing. The sockets 20, 30 can be configured so that they are non-coplanar, e.g., their axes are non-parallel to each other and oriented to angle away from the other, e.g., one angles forward and the other angles rearward in a Z direction. Stated differently, the axes 20a, 30a of the sockets 20, 30 can be offset from each other in a Z dimension. The diameter of the base is sufficient to hold the two (E26) sockets 20, 30.

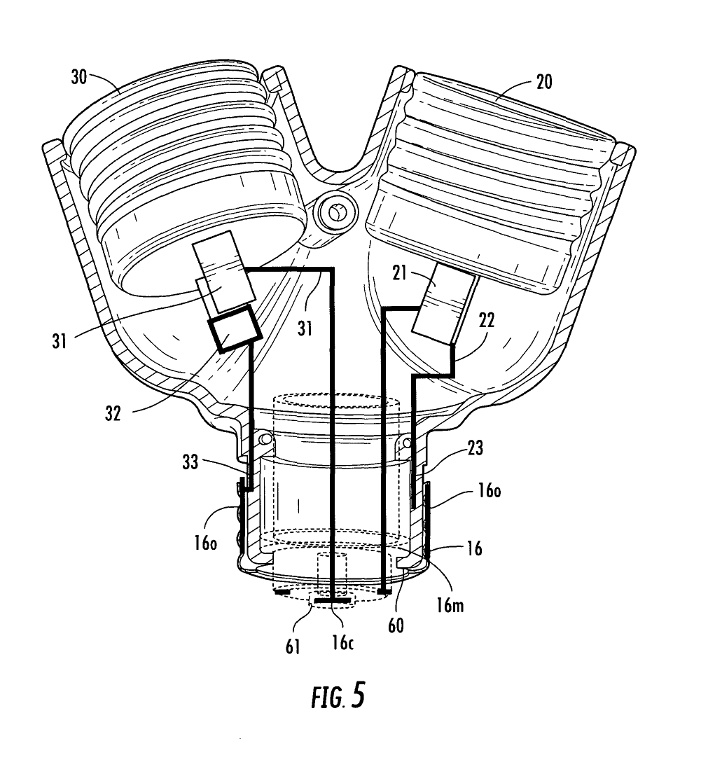

As shown in FIG. 5, the sockets 20, 30 can be wired to the lamp cap 16 so that the outer conductor 16o of the base 15 and the outer conductors 22, 32 of the sockets 20, 30 are common, the center conductor 16c of the base or cap 15 is attached to the center conductor 31 of one socket 30 and the middle conductor 16m of the base or lamp cap is connected to the center conductor 21 of the remaining socket 20.

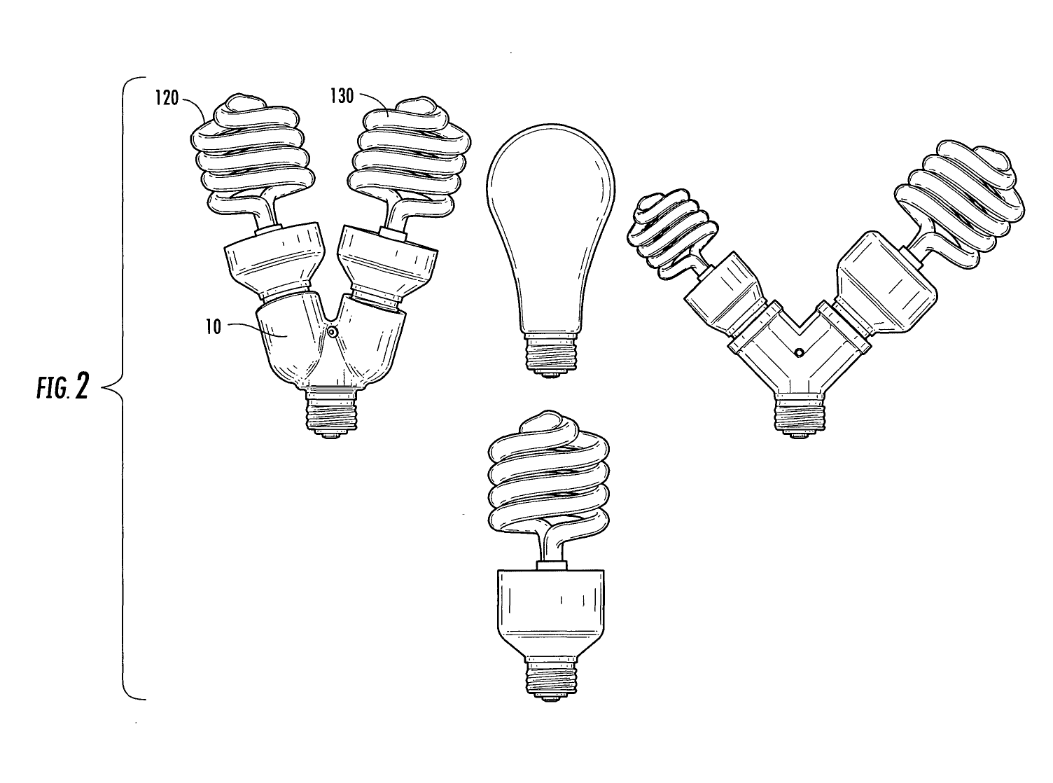

FIG. 2 illustrates the adapter 10 with two single wattage CFL bulbs 120, 130 according to embodiments of the present invention. The other devices shown in FIG. 2 illustrate different lamp adapters or bulb types. A consumer can insert any two single-wattage CFL bulbs into the device 10 and gain long-lasting, low cost, high quality, aesthetically pleasing, and energy efficient 3-way lighting. The adapter 10 may facilitate increased deployment of single wattage CFL bulbs in existing lamps. Of course, the adapter 10 may also be integrated into new lamps.

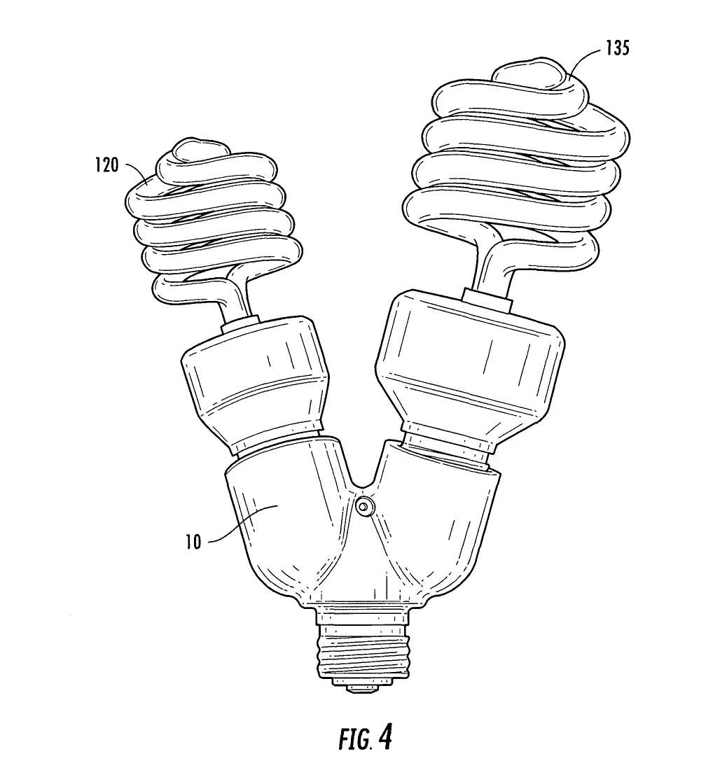

The two single wattage bulbs may be of the same wattage or may be of different wattage. An example of two different wattage bulbs 120, 135 is shown in FIG. 4. Such a configuration can provide a visual illumination effect substantially similar to a 50-100-150 W incandescent bulb. By easily adapting a 3-way incandescent lamp with an adapter 10 and two CFL bulbs, the lighting flexibility of the lamp is maintained while the efficacy of the lamp can increase by about a factor of 4 and the longevity of the bulbs can increase by a factor of about 8 (the average performance increase attributable to using CFLs rather than incandescent bulbs). The 3-way lighting illumination provided by the two different single wattage CFLs can be selected to be a different wattage equivalent, such as, but not limited to, for example, 100-200-300, 50-200-250, 50-100-150, and 30-70-100.

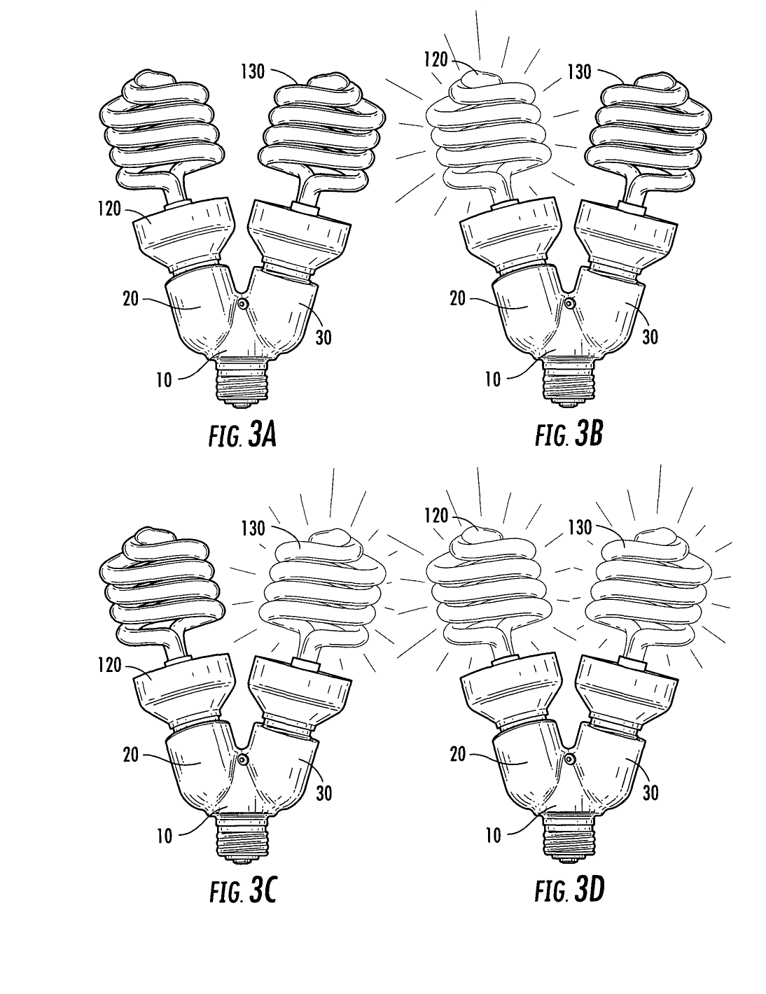

FIGS. 3A-3D illustrate different illuminations possible using the adapter 10 and two single wattage CFL bulbs 120, 130 in a 3-way light fixture according to embodiments of the present invention. FIG. 3A illustrates the lamp off. FIG. 3B illustrates one bulb 120 “on” with the lamp/adapter in position 1. FIG. 3B illustrates the other bulb 130 “on” in position 2 and FIG. 3D illustrates both bulbs 120, 130 “on” in position 3.

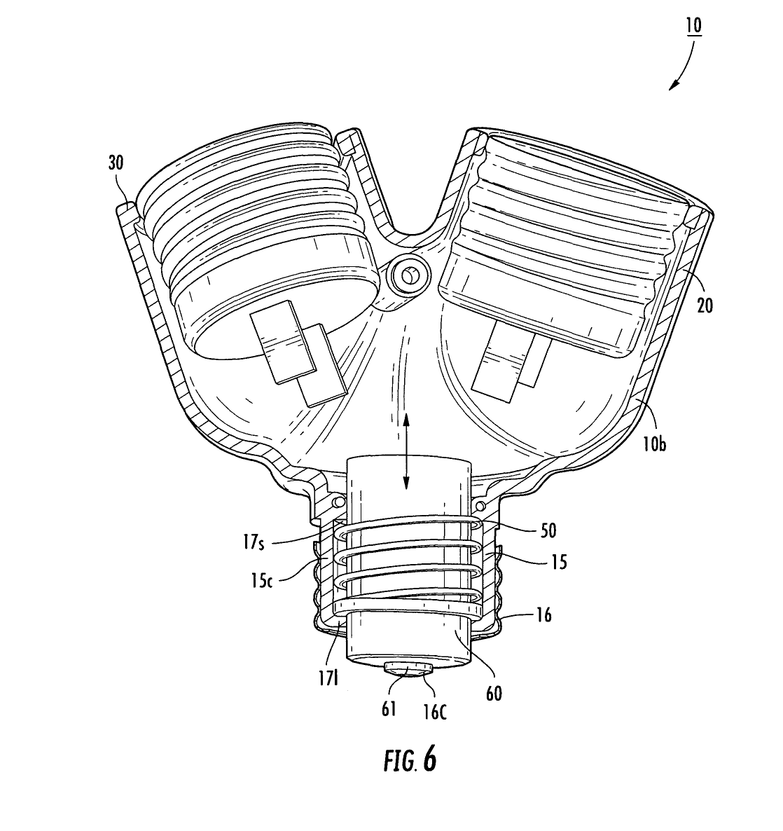

FIG. 6 illustrates that the adapter 10 can have a base cavity 15c with an internal plunger 60 that cooperates with a spring 50 to allow the adapter body 10b to rotate while still providing the electrical contacts with the inner conductors in the base, 16c, 16m, 16o. In some embodiments, the adapter housing or body 10b can rotate about 90 degrees to allow for optimal positioning of the sockets 20, 30 relative to the rest of the lamp/harp assembly 100 (FIGS. 7A, 7B). The spring-loaded plunger 60 resides in the base cavity 15c and holds the center conductor 16c in electrical communication with the lamp socket while the body of the adapter 10b can rotate and still also provide the electrical paths to the lamp/electric source. As shown, the plunger 60 extends through a bottom of the base 15. The plunger has a lowermost end portion 61. The center conductor 16m extends through the plunger 60 and contacts a light fixture socket. The base cavity 15 can have a lower radially extending internal lip 17l and an upper shelf 17s with the spring 50 residing around the plunger 60 trapped between the shelf 17s and lip 17l. The adapter 10 can to rotate while the plunger 60 remains extended to orient the sockets 20, 30 in a desired position.

The adapter 10 can alternately be configured with other rotational adjustment mechanisms, such as, for example, a sliding joint with a pair of overlying rotational members, a gear, a slotted channel, and the like. This rotation feature may be useful in conventional lamp fixture configurations/adapters as well. FIGS. 7A and 7B illustrate how the rotation adjustment feature allows a user to easily orient the adapter 10 and bulbs 120, 130 (135) inside a harp 101 of a lamp 100.

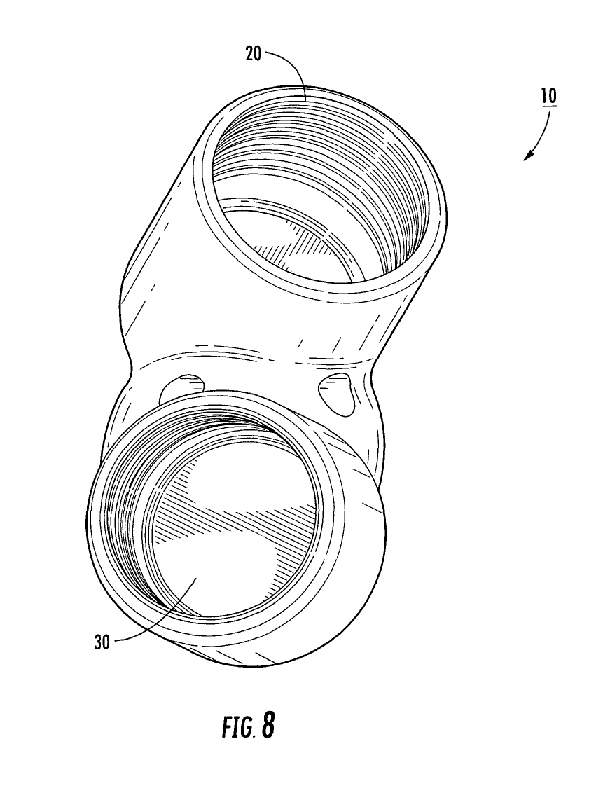

FIG. 8 is a top view (Y-Z plane) of the adapter 10 illustrating the non-coplanar sockets 20, 30. As shown, one socket 20 angles forward (the socket to the right) while the other socket 30 angles rearward (the socket to the left); each socket can angle upwardly at between about 30-45 degrees (angles 1 and 2, FIG. 1) from the centerline of the base 15 (FIG. 1). The axes 20a, 30a of the sockets 20, 30 can be offset from each other in a Z dimension. If rotated, this offset can be in another plane or dimension, e.g., the X dimension and/or the XY plane. This configuration allows the use of two CFL bulbs 120, 130 (135) and reduces the foot print of the adapter 10 so that it takes up a reduced space so it will fit into most existing lamp/harp/shade configurations. That is, where most 2-way bulb adapters are created with 3 spokes with the two female receptacles at 60-90 degrees in the XY plane (see, e.g., the adapter shown on the upper right side of FIG. 2), the adapters 10 according to embodiments of the invention arranges the two female receptacles 20, 30 at an angle of between about 30-45 degrees and so that the sockets are non-coplanar in the XY or Z plane/dimension.

The configuration of the two sockets 20, 30 allows two, single-wattage CFLs to be arrayed in such a way that the illuminance profile of the lamp and bulbs substantially resembles the illuminance profile of the lamp with a single bulb. The substantially matching illuminance profile of the two CFL bulbs in the adapter 10 relative to a single bulb in the lamp may be desirable to some consumers. In addition to the closely spaced XY alignment of the two female sockets 20, 30, further compactness can be achieved by making the sockets non-coplanar in the XZ axis (too). For clarity, it is noted that the X direction is the horizontal axis, the Y direction is the vertical axis and the Z axis or dimension is perpendicular to the X and Y directions (e.g., into and out of the paper) from the viewpoint of FIG. 1.

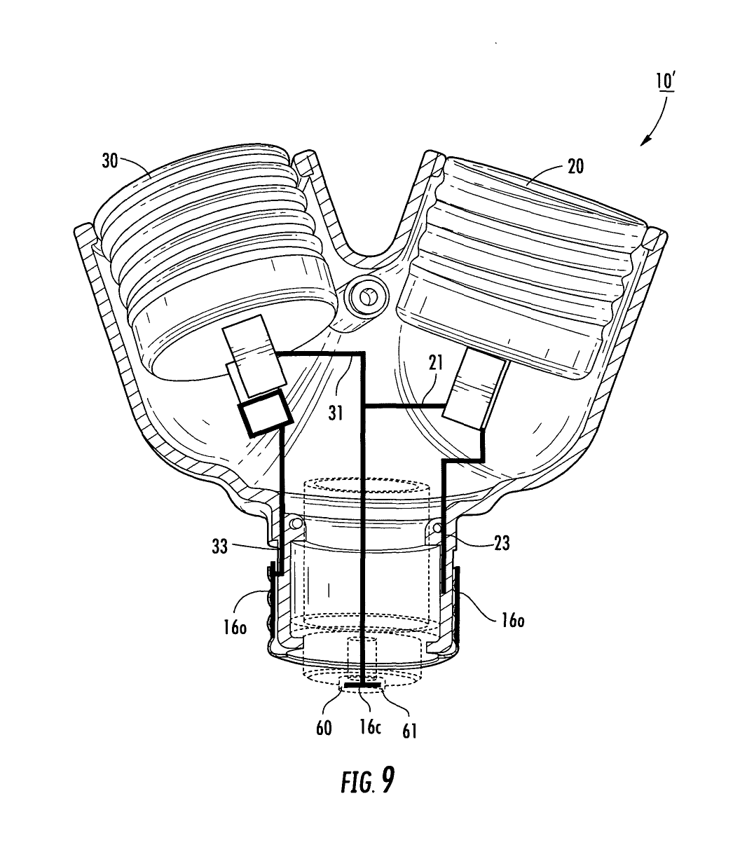

FIG. 9 illustrates another embodiment of the adapter 10′. In this embodiment, the adapter 10′ can include a circuit configuration that it is suitable for use in an Edison E26 socket (1-way) to allow for additional luminous flux from a second light bulb in the lamp fixture. The cap or male-threaded member 16 is an E26 (two-conductor) base 15, not a 3-conductor base. The center conductors 21, 31 of sockets 20, 30 connect to the base cap center conductor 16c. The outer conductors 23, 33 of the sockets 20, 30 connect to the base cap outer conductor 16o.

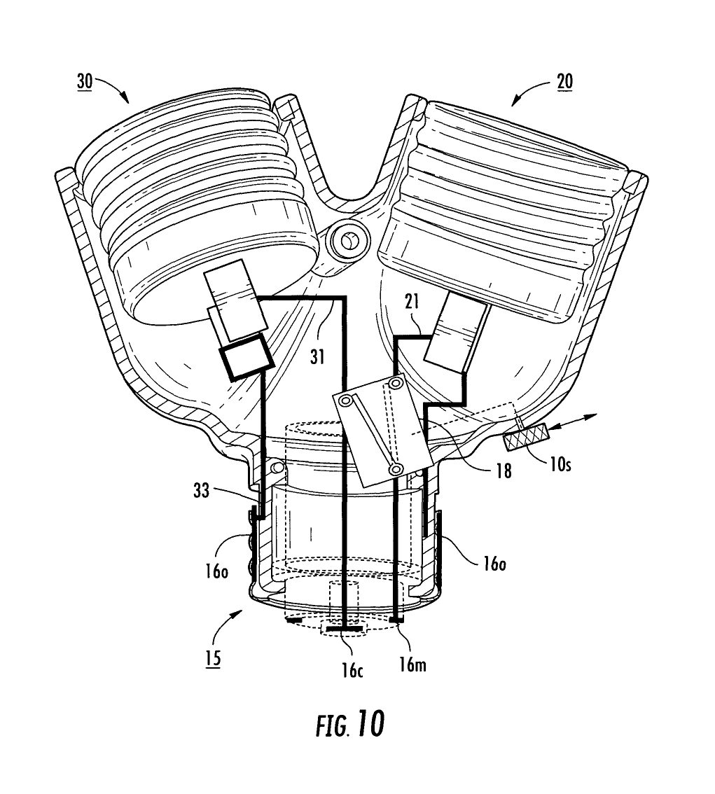

FIG. 10 illustrates yet another embodiment of the present invention. In this embodiment, the adapter 10″ includes a switch 10s that a user can activate to allow the adapter 10″ to operate either as a single lamp or as a three-way lamp. In one position the device 10″ behaves like the embodiment described with respect to FIG. 5, and by sliding the switch 10s to the other position, the device 10″ behaves like the embodiment described with respect to FIG. 9. That is, the adapter 10″ can operate as a one-way (on/off) lamp as well as a two or three way fixture.

As shown the base 15 includes the center conductor 16c and the outer conductor 16o as well as a middle conductor 16m. The adapter 10″ also includes a switch, shown as a single-pole double throw circuit switch 18 that is in communication with the user selectable switch 10s. A socket center conductor 31 extends to the base center conductor 16c. The other center conductor 21 extends to the base middle conductor 16m. The socket outer conductors 23, 33 extend to base outer conductors 16o. The switch 18 toggles between the middle conductor 16m and center conductor 16c.

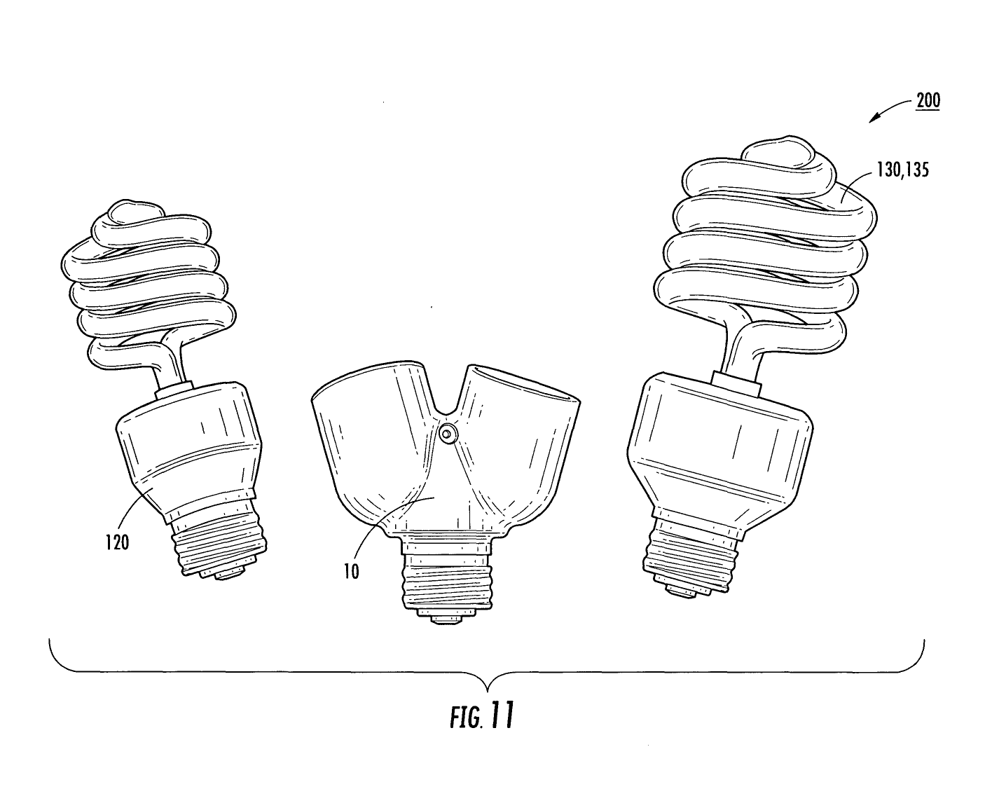

FIG. 11 illustrates a conversion kit 200 that can package two single wattage CFLs 120, 130 (or 135) with the adapter 10. The kit 200 can be for a single bulb lamp to convert to a two-bulb CFL lamp or may be for converting a three-way light fixture to a three-way illumination system using CFL bulbs.

In some particular embodiments, the adapter 10, 10′, 10″ can be configured to be sufficiently rugged that the temperature and current constraints of incandescent bulbs could be accommodated as well. That is, if a person wanted to use the adapter with two incandescent bulbs no unnecessary current or heat risks would be imposed. Thus, the adapter can comprise high temperature capable thermoforming material casting and appropriate current-capable conductors. However, in other embodiments, the package and/or adapter 10 can include a visible warning that this device is intended for CFLs only and any other use is not recommended.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

That which is claimed:

1. A light fixture conversion kit for allowing an incandescent lamp to accept two CFL bulbs in lieu of a single incandescent bulb, comprising:
an adapter comprising a base with two female sockets, each having an axis, the axes being offset from each other in a Z dimension, the sockets also extend upwardly at an angle that is between about 30-45 degrees from an axial centerline of the base, each socket configured to accept one single wattage CFL bulb; and
first and second single wattage CFL bulbs.

2. A light fixture conversion kit according to claim 1, wherein the first and second single wattage CFL bulbs have a different wattage.

3. A light fixture conversion kit according to claim 1, wherein the adapter comprises a user-switch that is in communication with an electrical path that allows the adapter to define three different electrical paths for a three-way light output to allow each one or both of the bulbs to be on or off, or to act as a single electrical path for both bulbs to be on or off.

4. A light fixture conversion kit according to claim 1, wherein the adapter is configured to convert a three-way incandescent light fixture of a single incandescent bulb to be able to accept two CFL bulbs, and wherein the adapter comprises an electric circuit that extends from the first and second sockets to the base, and wherein the electric circuit has a first path that activates a first bulb to an on position, a second path that activates a second bulb to an on position and a third path that activates both the first and second bulbs to an on position to thereby provide three different illumination configurations.

5. A light fixture conversion kit according to claim 1, wherein the base is configured to allow the first and second sockets to rotate to orient the first and second sockets in a desired position relative to a lamp harp while maintaining electrical contact with a lamp base.

6. A light fixture conversion kit according to claim 5, further comprising a base cavity with a spring loaded plunger therein, wherein the spring loaded plunger is configured to allow the adapter to rotate in a lamp socket while maintaining electrical contact with the lamp socket.

7. A light fixture adapter for allowing an incandescent lamp socket of a lamp to accept two CFL bulbs in place of a single incandescent bulb, the adapter having a body comprising a base with two female sockets extending upwardly at an angle that is between about 30-45 degrees from an axial centerline of the base, and each socket has an axis that is offset from the other in a Z dimension, wherein each socket is configured to accept one single wattage CFL bulb.

8. A light fixture adapter according to claim 7, wherein the adapter body comprises an electrical circuit with first socket inner and outer conductors and second socket inner and outer conductors, the first and second socket outer conductors connecting to an outer conductor on the base, the inner conductor of the second socket connecting to a middle conductor in the base, and the inner conductor of the first socket connecting to a center conductor in the base, whereby the adapter provides three different electrical paths for activating either the first socket on, the second socket on or both the first and second sockets on for a three-way light illumination options.

9. A light fixture according to claim 7, wherein the base has a base cavity and a plunger that extends through a lower portion thereof, the plunger cooperating with the adapter body to allow the adapter body to rotate while the plunger remains in electrical contact with a lamp socket inner conductors.

10. A light fixture, comprising:
an incandescent lamp fixture comprising a female light socket;
an adapter comprising a base with a threaded base cap releasably mounted to the incandescent lamp female light socket, the adapter having two upwardly extending female sockets, each socket holding a respective single wattage CFL bulb,
wherein the adapter defines electrical paths to activate bulbs in both of the two adapter sockets.

11. A light fixture according to claim 10, wherein the light fixture is a three-way light fixture, and wherein the adapter defines three different electrical paths for three different illumination configurations, including a first bulb only on, a second bulb only on, and first and second bulbs on concurrently.

12. A light fixture according to claim 10, the adapter further comprising a user-switch that engages an internal electrical switch that allows the adapter to act as a three-way light adapter or as a static single or dual light output.

13. A light fixture according to claim 10, wherein the base has a base cavity with a spring-loaded plunger having a conductor therein that communicates with at least one of the first and second female light sockets in the adapter and contacts the lamp fixture socket, and wherein the plunger is configured to allow the adapter to rotate with respect to the lamp fixture while the plunger is in electrical contact with the lamp fixture light socket.

14. A light fixture adapter having a male base with a metal cap having external threads that mates to a light fixture socket, the base having a cavity with a plunger that extends therethrough, the plunger having a lowermost end portion and conductor that contacts a light fixture socket, the base cavity having a lower radially extending internal lip and an upper shelf, with a spring residing around the plunger trapped between the shelf and lip, wherein the adapter is configured to rotate while the plunger remains extended to orient the sockets in a desired position.

15. An adapter according to claim 14, wherein the light fixture socket is configured to accept a single incandescent bulb, and wherein the adapter comprises two upwardly extending female sockets, each configured to accept a CFL bulb.

16. A light fixture adapter for allowing a 3-way incandescent lamp to accept two CFL bulbs in place of a single incandescent bulb, comprising:
an adapter comprising a base with two female sockets, each socket configured to accept one single wattage CFL bulb, wherein the adapter defines three different electrical paths for selective activation of either CFL bulb and both bulbs.

17. A light fixture adapter according to claim 16, wherein the adapter comprises an electrical circuit with first socket inner and outer conductors and second socket inner and outer conductors, the first and second socket outer conductors connecting to an outer conductor on the base, the inner conductor if the second socket connecting to a middle conductor in the base, and the inner conductor of the first socket connecting to a center conductor in the base, whereby the adapter provides three different electrical paths for activating either the first socket on, the second socket on or both the first and second sockets on for a three-way light illumination options.

18. A light fixture adapter according to claim 16, wherein the two female sockets comprise a respective upwardly extending axis, the axes being offset from each other in a Z dimension and extending at an angle that is between about 30 to about 45 degrees from an axial centerline of the base.
